(19) United States
(12) Patent Application Publication
(10) Pub. No.: US 2013/0030106 A1
(43) Pub. Date: Jan. 31, 2013

(54) HYBRID CLEAR MATTE PAINT COMPOSITION FOR A VEHICLE

(71) Applicant: Eun Young Chung, Gunpo (KR)

(72) Inventor: Eun Young Chung, Gunpo (KR)

(73) Assignees: KIA MOTORS CORPORATION, Seoul (KR); HYUNDAI MOTOR COMPANY, Seoul (KR)

(21) Appl. No.: 13/286,383

(22) Filed: Nov. 1, 2011

(30) Foreign Application Priority Data
Jul. 27, 2011 (KR) 10-2011-0074763

(51) Int. Cl. C09D 133/02; C09D 167/00; C09D 175/04; C08K 3/36

(52) U.S. Cl. 524/451

(57) ABSTRACT

Disclosed is a matte clear coat paint composition for a vehicle including a polymer resin for paint and a matting agent, the matting agent containing silica and talc. The disclosed matte clear coat paint composition for a vehicle reduces the amount of silica used as a matting agent, which is economically advantageous, in order to provide a matting effect equivalent to that of an existing matte clear coat paint compositions, and significantly reduces agglomeration of pigments, thereby providing a uniform application. Moreover, it is possible to prevent the occurrence of gloss due to friction with cloth, flannel, etc. and provide various textures by changing the type of talc.

### CROSS-REFERENCE TO RELATED APPLICATION

This application claims under 35 U.S.C. §119(a) the benefit of Korean Patent Application No. 10-2011-0074763 filed Jul. 27, 2011, the entire contents of which are incorporated herein by reference.

### BACKGROUND

(a) Technical Field

The present invention relates to a clear coat paint composition for a vehicle. More particularly, it relates to a hybrid matte clear paint composition, which can prevent agglomeration of pigments and provide a uniform application, thereby improving a vehicles appearance and merchantable quality.

(b) Background Art

As consumers' demands for attractive appearance of vehicles are diversified, various new colors and textures have been commercialized. As part of this movement, matte paints for a vehicle bodies have become a recent trend for consumers. As an example, matte paints exhibiting reduced gloss have been applied to high-end vehicles such as Mercedes Benz, BMW, etc as a specific styling option which can be chosen by consumers upon purchase.

A paint exhibiting a surface gloss of about 20 to 40 measured using a 60-degree gloss-meter, after an application to a vehicle, is defined as a matte paint. Existing glossy clear paints containing no matting agent regularly reflect the light to provide a glossy surface appearance (refer to FIGS. 1A and 1B). Meanwhile, existing matte clear paints for a vehicle bodies are typically prepared by mixing silica (SiO₂) about 8 wt % or higher of matting agent with the existing glossy clear paints to achieve a surface gloss of about 20 to 40 measured using a 60 angle gloss. Depending on the amount of inorganic matting agent mixed, the matte clear coat paints exhibit slightly rough textures (refer to FIGS. 2A and 2B), compared to the existing glossy painted surface.

In existing paints, in order to provide a surface gloss of 40 or less measured using a 60-degree gloss-meter, it is necessary to add silica in an amount of about 8 wt % or higher to obtain a matte effect. However, if the silica is added in an amount of 8 wt % or higher, the to pigments in the paint may agglomerate together, thereby making it very difficult to manufacture the paint and thus increases the manufacturing cost. That is, the oil absorption of the silica is about 100 to 190 mL/100 g, which is much larger than that of other pigments, and thus the agglomeration phenomenon easily occurs. Moreover, the agglomeration of pigment particles, which is not visible to the naked eye, is exposed on the surface of the vehicle body after application, thereby deteriorating its appearance quality. Moreover, since the uniformity and reproducibility of individual vehicles is low, the manufacturing cost, such as repainting, is increased during vehicle painting, thereby reducing the productivity.

Furthermore, a noticeable gloss is easily formed when friction occurs between the matte-coated surface and working clothes, cleaning cloth, flannel, etc., during assembly process after the painting process, which makes it very difficult to manage the painted vehicle body during the assembly process. Moreover, the gloss is easily damaged due to scratches occurring in everyday life do to usage, which makes it difficult to manage the vehicle even or the consumer. Accordingly, it is necessary to prevent the occurrence of glossing due to scratches and provide various textures, thereby increasing the degree of freedom in design. The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a matte clear coat paint composition for a vehicle, which can prevent agglomeration of pigments and provide a uniform matted surface by reducing the amount of silica used as a matting agent and mixing a pigment having low oil absorption into the paint's composition. As a result, the matte clear coat paint composition for a vehicle according to the present invention can reduce the amount of silica used as a matting agent and thus reduce the manufacturing cost, while maintaining the properties of existing matte clear coat paints, such as painting appearance, adhesion, impact resistance, water resistance, etc.

In one aspect, the present invention provides a matte clear coat paint composition for a vehicle comprising a polymer resin in paint and a matting agent. In particular, the matting agent includes a predetermined amount of silica and talc.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1A is schematic diagram showing the expression of gloss by an existing glossy clear paint;

FIG. 1B shows SEM images of the shape of an existing glossy clear paint;

FIG. 2A is a schematic diagram showing the expression of gloss by an existing matte clear paint;

FIG. 2B shows SEM images of the shape of an existing matte clear paint;

FIG. 3A is a schematic diagram showing the expression of gloss by a matte clear paint in accordance with an exemplary embodiment of the present invention; and

FIG. 3B shows SEM images of the shape of a matte clear paint in accordance with an exemplary embodiment of the present invention.

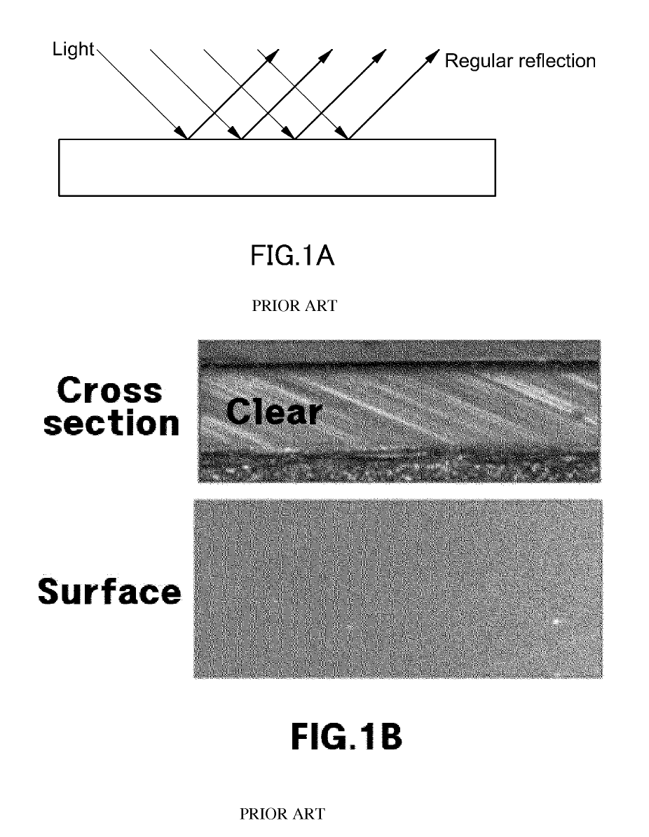

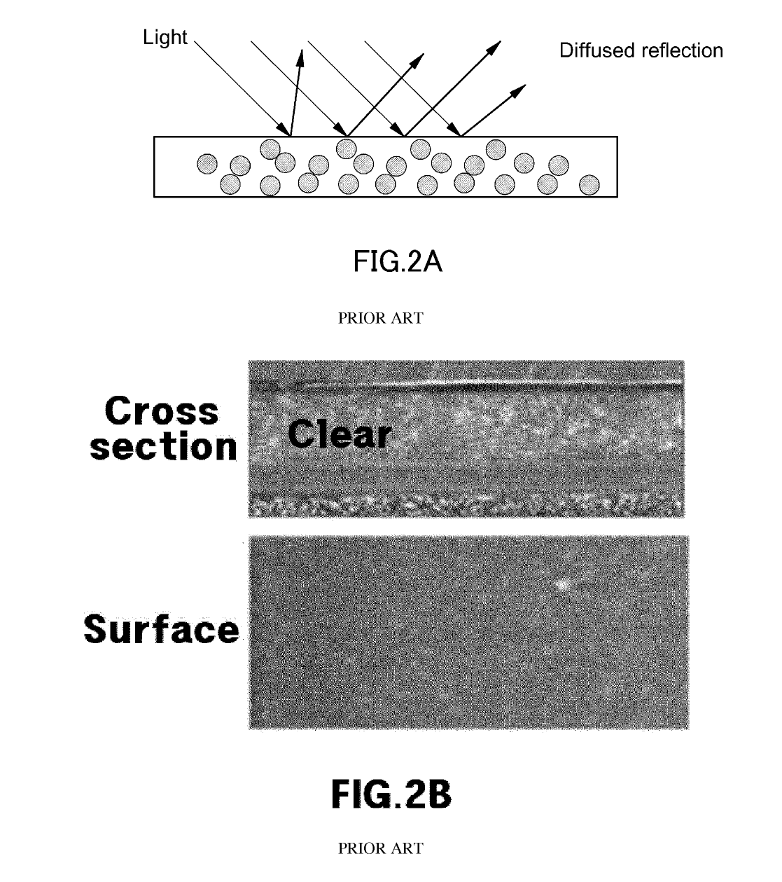

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

A matte clear coat paint composition for a vehicle according to the present invention includes a polymer resin for paint and a matting agent which includes silica and talc. More specifically, the silica is contained in an amount of about 1-8 wt % and the talc is contained in an amount of about 1 to 15 wt % with respect to the total weight of the matte clear paint composition. Thus, the amount of silica can be significantly reduced in most cases compared to existing matte clear coat paints which must include at least 8 wt % of silica, and the matte effect equivalent to that of the existing matte clear paints can be achieved by the to use of talc.

In an exemplary embodiment of the present invention, the diameter of the talc may be appropriately changed depending on the purpose and, preferably, the talc may have a diameter of about 5 to 15 μm, more preferably a diameter of about 8 to 14 μm, to improve the desired effect. More specifically, the talc may have an oil absorption of about 10 to 50 mL/100 g, more preferably an oil absorption of 20 to 40.

Moreover, in the present invention, as the polymer resin for paint, any resin for a clear coat paint can be used without limitations. For example, the polymer resin for paint may include but is not limited to an acrylic resin, a polyester resin, a urethane resin, etc.

In the present invention, the matte clear coat paint composition may contain at least one additive selected from the group consisting of a curing agent, an anti-pinhole agent, an anti-sagging agent, and a surface modifier, which are used in a typical clear paint composition. The curing agent cures the paint, and detailed examples of the curing agent may include, but not is limited to, a melamine resin, an isocyanate resin, etc. The anti-pinhole agent prevents the occurrence of pinholes in the paint, and an example of the anti-pinhole agent may include but is not limited to an acrylic copolymer. Preferably, the anti-pinhole agent may be used in an amount of 0.2 to 1.2 wt % with respect to the total weight of the matte clear coat paint composition. The anti-sagging agent prevents the flow of the paint, and an example of the anti-sagging agent may include an acrylic derivative. Preferably, the anti-sagging agent may be used in an amount of 0.1 to 1.0 wt % with respect to the total weight of the matte clear coat paint composition. The surface modifier improves the leveling (i.e., the feel and smoothness) of the paint, and an example of the surface modifier may include but is not limited to a modified silicon acryl. Preferably, the surface modifier may be used in an amount of 0.2 to 1.2 wt % with respect to the total weight of the matte clear paint composition.

Moreover, the paint composition may contain a typical solvent used for a vehicle paint, detailed examples of the solvent may include but is not limited to a hydrocarbon solvent, an alcohol solvent, an ester solvent, etc.

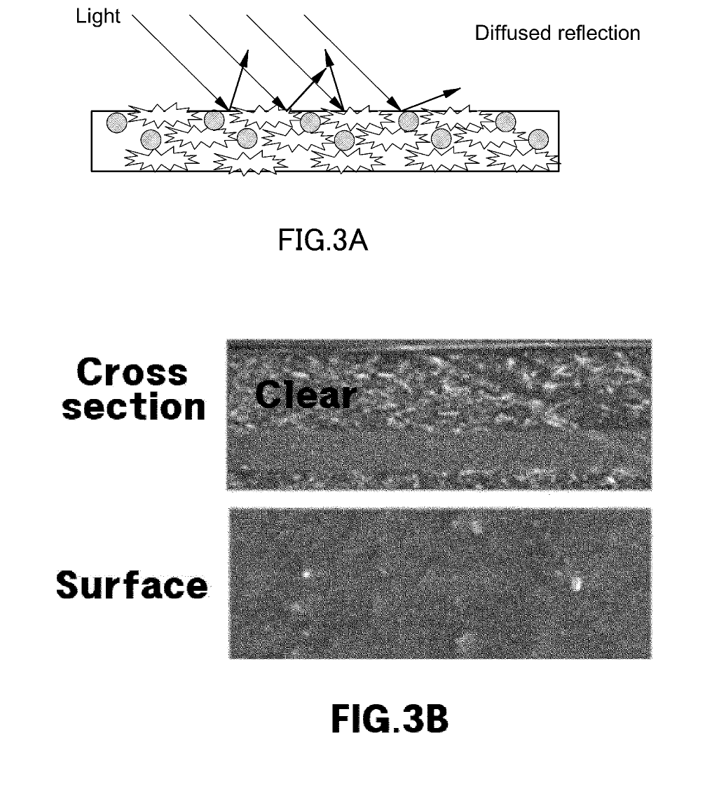

The clear paint composition according to the present invention containing talc as well as the existing silica used as the matting agent increases diffused reflection, thereby increasing matting effects. Moreover, even if the amount of matting agent used is reduced, it is possible to achieve an equivalent effect, which is economically advantageous over the prior art matting. Moreover, it is possible to provide various textures by changing the amount, size, and shape etc. of talc used (refer to FIGS. 3A and 3B).

Next, the present invention will be described with reference to the following examples, but the scope of the present invention is not limited thereto.

Examples and Comparative Examples

Clear coat paint compositions were prepared using the components shown in the following table 1, and the effects of gloss, an increase in gloss during friction, and texture were observed.

TABLE 1

| | | | | | Comp. | Comp. | Comp. | Comp. | Comp. |
|---|---|---|---|---|---|---|---|---|---|
| Classification | Example 1 | Example 2 | Example 3 | Example 4 | Ex. 1 | Ex. 2 | Ex. 3 | Ex. 4 | Ex. 5 |
| Silica (wt %) | 8 | 6 | 4 | 2 | 10 | 8 | 6 | 4 | 2 |
| Talc (wt %) | 2 | 4 | 6 | 8 | — | — | — | — | — |
| Gloss (60°) | 20 | 25 | 30 | 40 | 15 | 22 | 30 | 40 | 50 |
| Increase in | 25% | 20% | 14% | 11% | 43% | 35% | 29% | 25% | 14% |
| gloss during | | | | | | | | | |
| friction | | | | | | | | | |

| | | |
|---|---|---|
| Texture | Tough and heavy texture | Soft and fresh texture |

In the respective examples and comparative examples, only the matting agent is shown in the above table, and the types and amounts of polymer resin, solvent, and additives used are the same as those used in the typical clear coat paint.

As can be seen from the results of Table 1, the clear coat paint compositions prepared in Examples 1 to 4 of the present invention, in which the talc and silica were used together as the matting agents, exhibit excellent matting properties and less increase in gloss due to friction during use. They also provide various textures such as tough and heavy texture, compared to those prepared in Comparative Examples 1 to 5, in which only the silica was used as the matting agent. As a result, it can be seen that the matte clear coat paint composition according to the present invention can be effectively used as a matte paint for high-end vehicles.

As described above, the matte clear coat paint composition for a vehicle according to the present invention is able to reduce the amount of silica used and provide a matte effect equivalent to that of the existing matte clear paint composition in which only silica is used. Moreover, since the talc having low oil absorption is used together as the matting agent, it is to possible to significantly reduce the agglomeration of pigments, thereby providing a uniform application. Furthermore, it is possible to prevent the occurrence of gloss due to friction with cloth, flannel, etc., and provide various textures such as tough and heavy texture by changing the amount, size, shape, etc., of talc, compared to the existing matte paints in which only the silica is used as the matting agent.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A matte clear coat paint composition for a vehicle comprising a polymer resin for paint and a matting agent, wherein the matting agent comprises silica and talc.

2. The matte clear coat paint composition for a vehicle of claim 1, wherein the silica is contained in an amount of 1 to 10 wt % and the talc is contained in an amount of 1 to 15 wt % with respect to the total weight of the matte clear coat paint composition.

3. The matte clear coat paint composition for a vehicle of claim 1, wherein the talc has a diameter of about 5 to 15 μm and an oil absorption of about 10 to 50 mL/100 g.

4. The matte clear coat paint composition for a vehicle of claim 1, wherein the polymer resin for paint is selected from a group consisting of an acrylic resin, a polyester resin, and a urethane resin.

5. The matte clear coat paint composition for a vehicle of claim 1, further comprising at least one additive selected from the group consisting of a curing agent, an anti-pinhole agent, an anti-sagging agent, and a surface modifier.
